(19) United States
(12) Patent Application Publication
(10) Pub. No.: US 2026/0337417 A1
(43) Pub. Date: Oct. 29, 2026

(54) CURING AGENTS, MID-GLOSS POLYESTER-BASED POWDER COATINGS, AND METHODS RELATING TO SAME

(71) Applicant: ESTRON CHEMICAL, Calvert City, KY (US)

(72) Inventors: Fred Mitchell ALLEN, Paducah, KY (US); Anna CHIZHIKOVA, Duck River, TN (US); Terry Ray HOLLER, Paducah, KY (US); Michael Anthony POLANCO, JR., Clarksville, TN (US); Dustin Eli SMITH, Benton, KY (US)

(73) Assignee: ESTRON CHEMICAL, Calvert City, KY (US)

(21) Appl. No.: 19/175,158

(22) Filed: Apr. 10, 2025

(51) Int. Cl. C09D 5/03; C08F 220/14; C09D 167/00

(52) U.S. Cl. CPC C09D 5/03; C08F 220/14; C09D 167/00; C08F 2800/20; C08F 2810/20; C08F 2810/50

(57) ABSTRACT

The present disclosure relates to a curing agent composition comprising a glycidyl-functional poly(meth)acrylate polymer with about 10 wt % to about 20 wt % glycidyl (meth)acrylate units, about 50 wt % to about 80 wt % C1-C8 alkyl (meth)acrylate units, and about 8 wt % to about 15 wt % branched or cyclic C10-C20 hydrocarbyl or terpenyl (meth)acrylate units. Methods are provided for combining this polymer with a polyester having an acid value of about 20 to about 50 to yield an uncured powder coating composition, and for applying and curing this composition on a surface at 150° C. to 250° C. The resulting article comprises a surface with a cured coating formed from the cross-linked glycidyl-functional poly(meth)acrylate polymer and polyester. The cured coating may have both a mid-gloss effect and high visual smoothness.

### FIELD OF INVENTION

This disclosure relates to poly(meth)acrylate polymers with glycidyl units, and particularly, to using such polymers as curing agents in one-shot mid-gloss polyester-based powder coatings.

### BACKGROUND

Polyester-based powder coatings can routinely achieve high gloss finishes (e.g., finishes with 60° gloss values greater than about 45 gloss units) or matte finishes (e.g., finishes with 60° gloss values less than about 5 gloss units). Mid-gloss or semi-gloss finishes (e.g., finishes with 60° gloss values of 10 to 40 gloss units) are challenging to achieve. By “60° gloss” is meant that a surface under test is subjected to incident light at an angle of 60° from a plane perpendicular to the surface under test. One or more of: specular reflection, near-specular reflection, directional diffusion, and bulk scattering of the incident light by the surface under test are measured and the gloss value determined using glossimetry techniques and apparatus known in the art.

Conventionally, gloss is considered to be related to the smoothness of a surface such as that of a cured coating applied to or deposited on a substrate. The rougher or less smooth a cured coating, the more near-specular reflection, directional diffusion, or bulk scattering of incident light is expected, and the lower the expected gloss value. Visual smoothness on a macroscopic scale may be determined using the Powder Coating Institute (PCI) system, by comparing a surface under test with ten standards distributed by PCI, with visually smoother standards having higher PCI visual smoothness values.

Contact or non-contact (optical) profilometry techniques known in the art may be used to quantify microscopic-scale roughness of a cured coating surface. Linear or planar scans may be obtained that yield two-dimensional (2-D) or three-dimensional (3-D) roughness values, respectively, of a surface. One instrument used to obtain roughness values is the NANOVEA ST500 optical profiler (available from Nanovea, Inc., in Irvine, CA). 2-D roughness values include: arithmetic mean height (Pa); geometric mean height (Pq); maximum peak height (Pp); and maximum valley depth (Pv). 3-D roughness values include: arithmetic mean height (Sa) root mean square height (Sq); skewness (Ssk); kurtosis (Sku); maximum peak height (Sp), and maximum valley depth (Sv). However, no consensus has been established as to which profilometric technique or roughness value or values, if any, are correlated with 60° gloss values of polyester-based powder coatings.

There are currently approaches to achieve mid-gloss polyester-based powder coatings, such as use of extender pigments, wax additives, differential cure, or incompatible resins.

However, these approaches may require additional components and/or processing steps, may yield coatings with undesirable tactile, mechanical, or chemical properties, and may yield inconsistent results between batches.

Hence, there is a need in the art for “one-shot” polyester-based powder coatings wherein all essential ingredients are contained in a single formulation that consistently produce cured coatings with a mid-gloss finish and a high visual smoothness Such coatings should also provide acceptable thermomechanical properties as well as smear, smudge, chemical, and weather resistance desired for both interior and exterior applications.

### SUMMARY OF INVENTION

In some aspects, the present disclosure relates to a curing agent composition, comprising a glycidyl-functional poly(meth)acrylate polymer comprising about 10 wt % to about 20 wt % glycidyl (meth)acrylate units, about 50 wt % to about 80 wt % C1-C8 alkyl (meth)acrylate units, and about 8 wt % to about 15 wt % branched or cyclic C10-C20 hydrocarbyl or terpenyl (meth)acrylate units.

In some aspects, the present disclosure relates to a method, comprising a combination of: (a) a glycidyl-functional poly(meth)acrylate polymer comprising about 10 wt % to about 20 wt % glycidyl (meth)acrylate units, about 50 wt % to about 80 wt % C1-C8 alkyl (meth)acrylate units, and about 8 wt % to about 15 wt % branched or cyclic C10-C20 hydrocarbyl or terpenyl (meth)acrylate units; and (b) a polyester having an acid value of about 20 to about 50, wherein the combining is at a temperature below the ring and ball softening point of the glycidyl-functional poly(meth)acrylate polymer, to yield an uncured powder coating composition.

In some aspects, the present disclosure relates to a method, comprising an uncured powder coating composition consisting of: (a) a glycidyl-functional poly(meth)acrylate polymer comprising about 10 wt % to about 20 wt % glycidyl (meth)acrylate units, about 50 wt % to about 80 wt % C1-C8 alkyl (meth)acrylate units, and about 8 wt % to about 15 wt % branched or cyclic C10-C20 hydrocarbyl or terpenyl (meth)acrylate units; and (b) a polyester having an acid value of about 20 to about 50; placing the uncured coating composition on a surface of an article; and heating the uncured coating at a temperature of about 150° C. to about 250° C. for a duration of about 0.1 minutes per micron of thickness of the uncured coating to about 1 minute per micron of thickness of the uncured coating, to yield a cured coating on the surface.

In some aspects, the present disclosure relates to an article, comprising a surface; and a cured coating on the surface, wherein the coating comprises (a) a glycidyl-functional poly(meth)acrylate polymer comprising about 10 wt % to about 20 wt % glycidyl (meth)acrylate units, about 50 wt % to about 80 wt % C1-C8 alkyl (meth)acrylate units, and about 8 wt % to about 15 wt % branched or cyclic C10-C20 hydrocarbyl or terpenyl (meth)acrylate units; and

(b) a polyester having an acid value of about 20 to about 50, wherein the glycidyl-functional poly(meth)acrylate polymer and the polyester are cross-linked.

### BRIEF DESCRIPTION OF THE DRAWINGS

The following figures are included to illustrate certain aspects of the embodiments and should not be viewed as an exclusive embodiment. The subject matter disclosed is capable of considerable modifications, alterations, combinations, and equivalents in form and function, as will occur to those skilled in the art and having the benefit of this disclosure.

FIG. 1 depicts relationships between surface roughness Sa, and Sq and 60° gloss for cured polyester powder coatings prepared and measured as described herein.

FIG. 2 depicts relationships between 60° gloss and Mw, and Sa and Mw, as described in Example 8.

### DETAILED DESCRIPTION

In aspects, the present disclosure relates to single component mid-gloss polyester-based powder coating compositions that comprise a glycidyl-functional poly(meth)acrylate polymers and polyesters. When the glycidyl-functional poly(meth)acrylate polymers and the polyesters are substantially not crosslinked, the compositions may be referred to herein as “uncured powder coating compositions.” Glycidyl-functional poly(meth)acrylate polymers may be referred to herein as “curing agents.”

In some embodiments, the glycidyl-functional poly(meth)acrylate polymers may comprise about 10 wt % to about 20 wt % glycidyl (meth)acrylate units; about 50 wt % to about 80 wt % C₁-C₈ alkyl (meth)acrylate units; and about 8 wt % to about 15 wt % branched or cyclic C₁₀-C₂₀ hydrocarbyl or terpenyl (meth)acrylate units (e.g., isobornyl (meth)acrylate units), and the polyesters may have acid values of about 20 to about 50. In some embodiments, glycidyl-functional poly(meth)acrylate polymers having weight-average molecular weights (Mw) of about 4700 to about 5200 may provide cured coatings with arithmetic mean heights (Sa) of about 0.33 microns to about 0.55 microns and 60° gloss values of about 20 to about 40.

An uncured powder coating composition may be applied to a surface of an article, resulting in an uncured coating. The uncured coating may be cured by heating, to form a cured coating by crosslinking of the glycidyl-functional poly(meth)acrylate polymers and the polyesters. Cured coatings may impart to the surface of the coated article both high visual smoothness and a mid-gloss finish.

As used herein, “one-shot” or “one-component” or “single component” indicates that the polyester and other components of the coating, such as a curing agent, can be mixed in advance and the resulting mixture can then be deposited on a surface, rather than depositing the polyester and other components separately to create a coating on the surface. The term “mid-gloss” indicates that after curing, the coating has a 60° gloss value of about 10-40 gloss units as determined by glossimetry. The term “high visual smoothness” indicates that after curing, the coating has a value of 6 or higher on the PCI visual smoothness 1-10 scale.

Suitable curing agents for the powder coating compositions of the present disclosure are novel curing agent compositions that comprise glycidyl-functional poly(meth)acrylate polymers having various structural and functional properties described herein that may be particularly suitable as curing agents for inclusion in one-shot mid-gloss polyester-based coatings with high visual smoothness.

In some aspects, uncured powder coating compositions comprise a glycidyl-functional poly(meth)acrylate polymer and a polyester.

The glycidyl-functional poly(meth)acrylate polymers may comprise about 10 wt % to about 20 wt % glycidyl (meth)acrylate units; about 50 wt % to about 80 wt % C₁-C₈ alkyl (meth)acrylate units; and about 8 wt % to about 15 wt % branched or cyclic C₁₀-C₂₀ hydrocarbyl or terpenyl (meth)acrylate units.

A poly(meth)acrylate polymer, as that term is used herein, refers to a polymer comprising acrylate, substituted acrylate, methacrylate, and/or substituted methacrylate units having the structural formula corresponding to Formula 1 below:

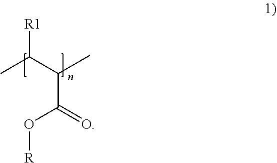

In Formula 1, independently in each unit, R1 is —H or —CH3 and R is an organic moiety.

A glycidyl-functional poly(meth)acrylate polymer herein refers to a poly(meth)acrylate polymer wherein in one or more methacrylate units, R is a glycidyl moiety according to Formula 2 below:

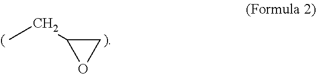

Suitable glycidyl-functional poly(meth)acrylate polymers for use in the curing agents disclosed herein may comprise glycidyl acrylate units and/or glycidyl methacrylate units (collectively glycidyl (meth)acrylate units). The amount of glycidyl (meth)acrylate units in glycidyl-functional poly(meth)acrylate polymers may be about 10 wt % to about 20 wt %, such as about 10 wt % to about 18 wt %, about 10 wt % to about 16 wt %, about 10 wt % to about 14 wt %, about 10 wt % to about 12 wt %, about 12 wt % to about 20 wt %, 14 wt % to about 20 wt %, 16 wt % to about 20 wt %, 18 wt % to about 20 wt %, 14 wt % to about 16 wt %, 14 wt % to about 16 wt %, 16 wt % to about 18 wt %, or any other range or value therebetween. As used herein, the term weight percentage (wt %) of any unit of a glycidyl-functional poly(meth)acrylate polymer is relative to all units in the glycidyl-functional poly(meth)acrylate polymer.

Suitable glycidyl-functional poly(meth)acrylate polymers for use in the curing agents disclosed herein may comprise C₁-C₈ alkyl (meth)acrylate units, in which R is a C₁-C₈ alkyl (meth)acrylate unit moiety. Such units include, but are not limited to, methyl acrylate units, ethyl acrylate units, propyl acrylate units, butyl acrylate units, pentyl acrylate units, hexyl acrylate units, heptyl acrylate units, octyl acrylate units, methyl methacrylate units, ethyl methacrylate units, propyl methacrylate units, butyl methacrylate units, pentyl methacrylate units, hexyl methacrylate units, heptyl methacrylate units, octyl methacrylate units, and any combination thereof. Alkyl groups of C₃-C₈ (meth)acrylate units may be in any isomeric form, e.g., the term “butyl acrylate units” includes linear butyl acrylate units, isobutyl acrylate units, and tert-butyl acrylate units, including cyclic and branched cyclic forms.

The amount of C₁-C₈ alkyl (meth)acrylate units in suitable glycidyl-functional poly(meth)acrylate polymers for use in curing agent compositions disclosed herein may be about 50 wt % to about 80 wt %, such as about 60 wt % to about 80 wt %, about 70 wt % to about 80 wt %, about 60 wt % to about 70 wt %, or about 65 wt % to about 70 wt %, or any other range or value therebetween. When two or more types of C₁-C₈ alkyl (meth)acrylate units are included in glycidyl-functional poly(meth)acrylate polymers, the different types of C₁-C₈ alkyl (meth)acrylate units may be present in any proportion. For example, glycidyl-functional poly(meth)acrylate polymers may comprise about 50 wt % to about 75 wt % methyl methacrylate units, such as about 50 wt % to about 60 wt %, or about 65 wt % to about 70 wt % methyl methacrylate units, or any other range or value therebetween, and about 0.1 wt % to about 2 wt % butyl acrylate units, such as about 0.6 wt % to about 1.0 wt % butyl acrylate units, or any other range or value therebetween.

Suitable glycidyl-functional poly(meth)acrylate polymers for use in curing agent compositions disclosed herein may comprise branched or cyclic C₁₀-C₂₀ hydrocarbyl or terpenyl (meth)acrylate units, in which R is a branched or cyclic C₁₀-C₂₀ hydrocarbyl or terpenyl moiety. Terpenyl herein refers to compounds comprising one or more isoprene units. Terpenyl moieties may be hydrocarbons and/or functionalized hydrocarbon compounds.

Terpenyl moieties may be linear, branched, cyclic, and/or polycyclic.

Examples of suitable branched or cyclic C₁₀-C₂₀ hydrocarbyl or terpenyl (meth)acrylate units may comprise units selected from the group consisting of monoterpenyl (meth)acrylate units, monoterpenoidyl (meth)acrylate units, sesquiterpenyl (meth)acrylate units, sesquiterpenoidyl (meth)acrylate units, diterpenyl (meth)acrylate units, diterpenoidyl (meth)acrylate units, and any combination thereof. Branched or cyclic C₁₀-C₂₀ hydrocarbyl or terpenyl (meth)acrylate units may comprise isobornyl acrylate units, e.g. units having Formula I wherein R1 is —H and R is an isobornyl group corresponding to Formula 3:

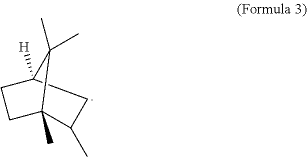

and/or isobornyl methacrylate units, e.g., units having Formula I wherein R1 is —CH₃ and R is an isobornyl group corresponding to Formula 3.

Collectively, isobornyl acrylate units and isobornyl methacrylate units may be referred to herein as “isobornyl (meth)acrylate units”).

In some embodiments, the amount of branched or cyclic C₁₀-C₂₀ hydrocarbyl or terpenyl (meth)acrylate units in glycidyl-functional poly(meth)acrylate polymers may be about 8 wt % to about 15 wt %, such as about 8 wt % to about 14 wt %, about 8 wt % to about 12 wt %, about 10 wt % to about 14 wt %, or about 10 wt % to about 12 wt % branched or cyclic C₁₀-C₂₀ hydrocarbyl or terpenyl (meth)acrylate units, or any other range or value therebetween.

An example of a glycidyl-functional poly(meth)acrylate polymer suitable for use in curing agent compositions of the present disclosure comprises about 10 wt % to about 14 wt % glycidyl methacrylate units, about 50 wt % to about 70 wt % methyl methacrylate units, about 0.6 wt % to about 1 wt % butyl acrylate units, and about 8 wt % to about 12 wt % isobornyl acrylate units, summing up to 100 wt %. Another example of a glycidyl-functional poly(meth)acrylate polymer suitable for use as a curing agent of the present disclosure comprises about 12 wt % to about 16 wt % glycidyl methacrylate units, about 65 wt % to about 75 wt % methyl methacrylate units, about 0.6 wt % to about 1 wt % butyl acrylate units, and about 10 wt % to about 14 wt % isobornyl acrylate units. Taken together, the weight percentages of the units total 100 wt %.

Suitable glycidyl-functional poly(meth)acrylate polymers for use in curing agent compositions disclosed herein may have ring and ball softening points of about 100° C. to about 135° C., such as about 105° C. to about 130° C., about 110° C. to about 120° C., or any other range or value therebetween. The ring and ball softening point may be determined pursuant to ASTM E28.

Additionally, in some embodiments, suitable glycidyl-functional poly(meth)acrylate polymers for use in curing agent compositions disclosed herein may have epoxide equivalent weights (EEW) of about 700 to about 1300, such as about 900 to about 1100, about 1000 to about 1100, or any other range or value therebetween. EEW is calculated herein as grams polymer/mole epoxide moieties, both of which values may be determined as a routine matter by the person of ordinary skill in the art.

In some embodiments, suitable glycidyl-functional poly(meth)acrylate polymers for use in curing agent compositions disclosed herein may have glass transition temperatures (T_{g}) of about 45° C. to about 80° C., such as about 50° C. to about 70° C., about 55° C. to about 60° C., about 60° C. to about 65° C., or any other range or value therebetween. T_{g} may be determined by any appropriate technique, e.g., by differential scanning calorimetry pursuant to ASTM E135623 or ASTM D7426-23. In some embodiments, suitable glycidyl-functional poly(meth)acrylate polymers for use in the curing agent compositions disclosed herein may have number-average molecular weights (Mn) of about 1600 to about 3400, such as about 2000 to about 2800, about 2400 to about 3000, or any other range or value therebetween. Mn may be calculated as ΣNᵢMᵢ, where Mᵢ is the molecular weight of a polymer molecule and Nᵢ is the mole fraction of molecules with that molecular weight. Mn may be predicted from parameters of the polymerization reaction or calculated from molecular weight analysis of a representative sample of polymer molecules using techniques such as gel permeation chromatography (GPC), light scattering, viscometry, and/or end-group analysis. In some embodiments, glycidyl-functional poly(meth)acrylate polymers for use in the curing agent compositions disclosed herein may have weight-average molecular weights (Mw) of about 3800 to about 6300, such as about 4000 to about 5500, about 4600 to about 5000, about 4700 to about 5200, or any other range or value therebetween. Mw may be calculated as ΣNᵢMᵢ²/ΣMᵢ, where Mᵢ, Nᵢ, and techniques for predicting or calculating molecular weights are as described above for Mn.

In some embodiments, suitable glycidyl-functional poly(meth)acrylate polymers may have viscosities of about 50 cPs to about 250 cPs, such as about 80 cPs to about 150 cPs, about 85 cPs to about 110 cPs, or any other range or value therebetween, as determined by a cone and plate viscometer at 175° C. and 100 rpm for a duration of 2 minutes, pursuant to ASTM D4287.

In some embodiments, suitable glycidyl-functional poly(meth)acrylate polymers may be described by one or more of the following properties selected from the group consisting of: ring and ball softening points of about 100° C. to about 135° C.; epoxide equivalent weights (EEW) of about 700 to about 1300; glass transition temperatures of about 45° C. to about 80° C.; number-average molecular weights (Mn) of about 1600 to about 3400; weight-average molecular weights (Mw) of about 3800 to about 6300; viscosities of about 50 cPs to about 250 cPs; and any combination thereof.

In one example, a suitable glycidyl-functional poly(meth)acrylate polymer for use in the curing agent compositions disclosed herein can be described by all of the following: a ring and ball softening point of about 100° C. to about 135° C.; an epoxide equivalent weight (EEW) of about 700 to about 1300; a glass transition temperature of about 45° C. to about 80° C.; a number-average molecular weight (Mn) of about 1600 to about 3400; a weight-average molecular weight (Mw) of about 3800 to about 6300; and a viscosity of about 50 cPs to about 250 cPs.

In addition to glycidyl-functional poly(meth)acrylate polymers, the curing agent compositions of the present disclosure may comprise small amounts of other compounds suitable for use in curing agent compositions such as initiators, solvents, and/or antioxidants, among others. For example, compositions may include up to about 5 wt % of a suitable initiator, such as about 0.2 wt % to about 4 wt % of an organic peroxide initiator, e.g., commercially available as TRIGONOX 127 and/or TRIGONOX 121 (available from Nouryon, Amsterdam, Netherlands); up to about 0.5 wt % of an antioxidant, such as about 0.05 wt % to about 0.2 wt % butylated hydroxytoluene (BHT); and/or up to about 5 wt % of a solvent, such as about 1 wt % to about 3 wt % xylene; among other materials, including but not limited to unreacted monomers and/or styrene.

As stated above, powder coating compositions disclosed herein comprise polyesters in addition to the curing agent. Suitable polyester may have an acid value of about 20 to about 50, such as about 20 to about 30, about 30 to about 40, about 40 to about 50, or any other range or value therebetween. For example, suitable polyesters may have an acid value of about 35.

Acid values herein are calculated as mg of KOH required to titrate the carboxylic acid groups of 1 g of the polyester, pursuant to ASTM D7253.

Any polyester having an acid value of about 20 to about 50 is suitable for use in the powder coating compositions of this disclosure. Examples of suitable commercially-available polyesters include, but are not limited to, CC2440-0, CC2441-2, CC2606-2, CC4430-0, and CC4478 (available from Allnex GmbH, Wiesbaden, Germany); SP-011 and SP-6400 (available from Sun Polymers, Mooresville, Indiana, USA); REAFREE 4705 and REAFREE 6700 (available from Arkema Inc., King of Prussia, Pennsylvania, USA); URALAC 6620 and URALAC 6701 (available from Covestro AG, Leverkusen, Germany); and ALYMERS TC3006 (available from Inopol, Busan, South Korea), among others.

In the powder coating compositions disclosed herein, the polyesters and the curing agent may be present in any suitable weight ratio. For example, the weight ratios of polyester and curing agent may be about 40:60 to about 80:20, such as about 50:50 to about 70:30, or any other range or value therebetween. Weight ratios of polyesters and the glycidyl-functional poly(meth)acrylates in the curing agent may be about 40:60 to about 80:20, such as about 50:50 to about 70:30, about 55:45 to about 65:35, about 58:42 to about 63:37, about 60:40, or any other range or value therebetween. One having ordinary skill in the art with the benefit of this disclosure will be able to determine the appropriate ratios of components based on the end use and desired results.

At least in some embodiments, the powder coating compositions comprising suitable polyesters and curing agents, as described herein, in weight ratios as described herein, may allow substantially complete cross-linking between carboxylic acid groups of the polyesters and the epoxide groups of the glycidyl-functional poly(meth)acrylates of the curing agent during curing, without the need for secondary cross-linkers such as triglycidyl isocyanurate (TGIC) and hydroxyalkylamides (HAA).

A powder coating composition comprising a glycidyl-functional poly(meth)acrylate polymer and a polyester may be termed an “uncured powder coating composition” if the composition has not been subjected to a temperature above the ring and ball softening point of the glycidyl-functional poly(meth)acrylate polymer in the curing agent, and may be termed a “cured coating” if the glycidyl-functional poly(meth)acrylate polymer if the composition has been subjected to a temperature above the ring and ball softening point of the glycidyl-functional poly(meth)acrylate polymer. When a “cured powder coating composition” is on an article, that article has a resulting cured coating and is a coated article.

In addition to the curing agents and polyesters as described herein, the powder coating compositions of the present disclosure may further comprise one or more optional additives known for use in powder coating applications if desired.

Such optional additives may include catalysts that promote cross-linking between the epoxide moieties of glycidyl-functional poly(meth)acrylate polymers of the curing agent and the carboxylic acid moieties of the polyesters. Examples of suitable catalysts include imidazole catalysts, which comprise heterocyclic diazole moieties. Examples of suitable imidazole catalysts include, but are not limited to, catalysts comprising 2-isopropylimidazole and castor wax moieties, such as ESCAT 50, or catalysts comprising 2-n-propylimidazole moieties and silica, such as ESCAT 60, among other ESCAT series catalysts, such as ESCAT 73 (all available from Estron Chemical Inc., Calvert City, Kentucky, USA); catalysts comprising 2-phenylimidazole moieties, such as DYHARD PI (available from Alzchem Group AG, Trostberg, Germany), 2-iso-propyl imidazole (available from Shanghai Holdenchem Co. Ltd. China,) 2-n-propyl imidazole (available from Shanghai Holdenchem Co. Ltd China, and zinc 2-mercaptobenzothiazole (ZMBT; available from Acrochem Co. Akron USA), among others.

If present in a powder coating composition of the present disclosure, a catalyst may be present in any suitable amount, such as up to about 1 wt % of the powder coating composition, including about 0.1 wt % to about 1 wt %, about 0.3 wt % to about 1 wt %, about 0.3 wt % to about 0.6 wt %, about 0.6 wt % to about 1 wt %, or any other range or value therebetween. One having ordinary skill in the art with the benefit of this disclosure will be able to determine the appropriate amount of catalyst to include based on the end use and desired results.

In another example, the powder coating compositions described herein may comprise flow control agents. Flow control agents may reduce surface defects, such as orange peel, craters, or pinholes, in cured coatings. Flow control agents that may be used include, but are not limited to, members of the RESIFLOW® series, e.g., RESIFLOW PL-200, RESIFLOW P-64F, RESIFLOW PH-241, and RESIFLOW PL-330 (available from Estron Chemical Inc., Calvert City, Kentucky, USA).

If present, a flow control agent may be included in the powder coating composition in any amount, such as about 0.1 wt % to about 2 wt %, about 0.5 wt % to about 1.5 wt %, about 0.5 wt % to about 1 wt %, about 1 wt % to about 1.5 wt %, or any other range or value therebetween. One having ordinary skill in the art with the benefit of this disclosure will be able to determine the appropriate amount of flow control agent to include based on the end use and desired results.

Optionally, the powder coating compositions described herein may comprise degassing agents to scavenge oxygen present during curing and/or minimize bubble formation in cured coatings. Examples of suitable degassing agents include, but are not limited to, benzoin and members of the OXYMELT® series, e.g OXYMELT A-2, OXYMELT A-6, and OXYMELT A-7 (available from Estron Chemical Inc., Calvert City, Kentucky, USA).

If present in the powder coating compositions, degassing agents may be included in any amount, such as about 0.1 wt % to about 1 wt %, about 0.2 wt % to about 1 wt %, about 0.2 wt % to about 0.5 wt %, about 0.5 wt % to about 1 wt %, or any other range or value therebetween. One having ordinary skill in the art with the benefit of this disclosure will be able to determine the appropriate amount of degassing agent to include based on the end use and desired results.

Optionally, the powder coating compositions described herein may comprise pigments. Pigments may impart a desired color, shade, or tint to cured coatings. Examples of suitable pigments include carbon black and SPECIAL BLACK® 6 (Orion S. A., Spring, Texas, USA), among others. If used, pigments may be included in powder coating composition in any amount, such as about 0.1 wt % to about 2 wt %, about 0.5 wt % to about 1.5 wt %, about 0.5 wt % to about 1 wt %, about 1 wt % to about 1.5 wt %, or any other range or value therebetween. One having ordinary skill in the art with the benefit of this disclosure will be able to determine the appropriate amount of pigment to include based on the end use and desired results.

In some embodiments, the powder coating compositions may comprise fillers, which are inexpensive materials that reduce material costs by providing bulk to the powder coating compositions. Examples of suitable fillers include barium sulfate, e.g., CIMBARQ UF (available from TRiiSO LLC, Del Mar, California, USA) or BLANC FIXE MICRO (available from Azelis Group, Antwerp, Belgium), among others. If used, fillers may be included in powder coating composition in any amount, such as about 5 wt % to about 50 wt %, about 10 wt % to about 30 wt %, about 20 wt % to about 30 wt %, about 20 wt % to about 25 wt %, or any other range or value therebetween. One having ordinary skill in the art with the benefit of this disclosure will be able to determine the appropriate amount of filler to include based on the end use and desired results.

In particular examples, the powder coating compositions of the disclosure may comprise at least one compound selected from the group consisting of: catalysts, flow control agents, degassing agents, pigments, fillers, and any combination thereof.

In their uncured state, the powder coating compositions described herein may be formulated as homogenous solid particles, pellets, or powders of any desired particle size. In some instances, the particle size of the particles, pellets, or powders may be small enough to pass through a 140 US-mesh sieve or have an average particle size smaller than about 105 microns (0.0041 inches).

The powder coating compositions of the present disclosure may be used in coating applications for any desired surface to form a cured coating on that surface when cured, the cured coating comprising crosslinked polyester and the glycidyl-functional poly(meth)acrylate. The resulting cured coatings may impart one or more of the following properties: water resistance, ultraviolet light (UV) resistance, mid-gloss finish, reduced surface defects, high visual smoothness, and/or other desirable properties to surfaces of substrates.

For example, in some instances, the cured coating may have 60° gloss values of about 5 gloss units to about 45 gloss units, such as about 10 gloss units to about 40 gloss units, about 10 gloss units to about 20 gloss units, about 20 gloss units to about 40 gloss units, about 20 gloss units to about 30 gloss units, about 30 gloss units to about 40 gloss units, or any other range or value therebetween. In a specific example, the cured coating may impart a mid-gloss finish to surfaces coated therewith.

Unexpectedly, the cured coatings produced by the powder coating compositions of this disclosure may provide a mid-gloss effect, suggestive of a relatively high roughness at least at small scales, with a high visual smoothness, e.g., may have a PCI visual smoothness of 6 to 10.

The present disclosure also provides methods of forming an uncured powder coating composition comprising: combining (a) glycidyl-functional poly(meth)acrylate polymers comprising about 10 wt % to about 20 wt % glycidyl (meth)acrylate units; about 50 wt % to about 80 wt % C₁-C₈ alkyl (meth)acrylate units; and about 8 wt % to about 15 wt % branched or cyclic C₁₀-C₂₀ hydrocarbyl or terpenyl (meth)acrylate units; and (b) polyesters having an acid value of about 20 to about 50, wherein the combining is at a temperature below the ring and ball softening point of the glycidyl-functional poly(meth)acrylate polymer, to yield an uncured powder coating composition.

In the methods, glycidyl-functional poly(meth)acrylate polymers and polyesters, and weight ratios thereof, may be as described herein. The glycidyl-functional poly(meth)acrylate polymers may be added in neat form or as components of curing agent compositions comprising, e.g., initiators, antioxidants, solvents, unreacted monomers, and/or styrene as described herein. Glycidyl-functional poly(meth)acrylate polymers and polyesters may be further combined with (c) compounds selected from the group consisting of catalysts, flow control agents, degassing agents, pigments, fillers, and any combination thereof. Such compounds may be as described herein.

Glycidyl-functional poly(meth)acrylate polymers and polyesters, and additional compounds, if any, may be combined by any appropriate technique. For example, solid particulate feedstocks of glycidyl-functional poly(meth)acrylate polymers, polyesters, and any additional compounds may be blended to form a mixture of heterogeneous particles, followed by co-extrusion. Co-extrusion may be performed using known apparatus and techniques. Co-extrusion may comprise multi-zone heating of the mixture, with one or more zones at about 65° C. to about 70° C., and one or more zones at about 100° C. to about 105° C. During heating, the mixture may be rotated, e.g., at about 200 rpm to about 350 rpm, during heating. Co-extrusion may also be performed with torque of about 40% to about 75%. Co-extrusion conditions may be chosen to minimize premature cross-linking of glycidyl-functional poly(meth)acrylate polymers and polyesters.

After co-extrusion, the extrudate may be cooled, ground, and screened, e.g., by 140-mesh, to yield an uncured powder coating composition comprising particles of a desired maximum average particle size. Alternatively, or additionally, the extrudate may be re-extruded prior to preparation of a final uncured powder coating composition. An uncured powder coating composition undergoing only a single extrusion process may be referred to herein as “extruded once” or “1× extruded.” An uncured powder coating composition prepared by re-extrusion of an extrudate may be referred to herein as “extruded twice” or “2× extruded” or grammatical variants thereof.

Uncured powder coating compositions produced by these methods may be used for powder coating surfaces of substrates.

In some aspects, the present disclosure also provides methods comprising coating a surface with an uncured powder coating composition described herein that includes: providing an uncured powder coating composition that comprises (a) glycidyl-functional poly(meth)acrylate polymers comprising about 10 wt % to about 20 wt % glycidyl (meth)acrylate units; about 50 wt % to about 80 wt % C₁-C₈ alkyl (meth)acrylate units; and about 8 wt % to about 15 wt % branched or cyclic C₁₀-C₂₀ hydrocarbyl or terpenyl (meth)acrylate units; and (b) polyesters having acid values of about 20 to about 50; placing the uncured coating composition on the surface of an article; and heating the uncured coatings at a temperature of about 150° C. to about 250° C. for duration of about 0.1 minutes per micron of thickness of the uncured coatings to about 1 minute per micron of thickness of the uncured coatings, to yield cured coatings on the surfaces.

Any surface may be coated with the uncured powder coating composition. Surfaces that may be coated include, but are not limited to, surfaces comprising metals or alloys, such as may be found on articles such as automotive parts, appliances, outdoor furniture, or construction materials, among others; surfaces comprising wood, such as may be found on articles such as outdoor furniture or construction materials, among others; surfaces comprising plastics, such as may be found on articles such as appliances or outdoor furniture, among others; and surfaces comprising ceramics or glass, such as may be found on articles such as appliances; among others.

Placing the uncured coating composition on an article may involve spraying a desired surface with an uncured powder coating composition of the present disclosure, dipping articles or surfaces thereof into solutions or suspensions containing an uncured powder coating composition of the present disclosure in a solvent or liquid phase, or other suitable techniques known in the art.

Heating the uncured coating composition on the surface of the article may be performed using any appropriate technique and apparatus, e.g., ovens heat lamps, heat guns, among others. In some instances, the heating temperature may be about 150° C. to about 250° C., such as about 175° C. to about 225° C., about 190° C. to about 210° C., about 200° C. to about 205° C., or any other range or value therebetween.

The duration of the heating process may vary depending on the characteristics of the uncured coating composition as well as the characteristics of the uncured coating on the surface. For instance, the heating duration may be about 0.1 minutes per micron of thickness of the uncured coating to about 1 minute per micron of thickness of the uncured coating, such as about 0.3 minutes per micron to about 0.8 minutes per micron, about 0.4 minutes per micron to about 0.7 minutes per micron, about 0.5 minutes per micron to about 0.6 minutes per micron, or any other range or value therebetween. One having ordinary skill in the art with the benefit of this disclosure will be able to determine the appropriate heating duration based on the end use and desired results.

One should note that the gloss values of the cured coatings may have a positive correlation with heating temperature. In other words, at least in some instances, a higher temperature may lead to a higher gloss value. This may be true even at a shorter heating duration. For example, heating at 210° C. for 10 minutes or 200° C. for 15 minutes may lead to a higher gloss value than heating at 180° C. for 30 minutes.

Some heating methods may further comprise monitoring a transient gloss of the uncured coating during the heating; wherein the heating is terminated when the transient gloss has about a selected value. The term “transient gloss” as used herein refers to the 600 gloss value at any moment during heating. The transient gloss may be monitored by any appropriate technique and apparatus, e.g., by glossimetry as known in the art. The selected value may be predetermined prior to coating or the commencement of heating, or may be selected during heating based on evolution of transient gloss values, operator judgment, and/or other factors known in the art.

Methods may produce cured coatings having a 60° gloss of about 5 gloss units to about 45 gloss units, such as about 10 gloss units to about 40 gloss units, about 10 gloss units to about 20 gloss units, about 20 gloss units to about 40 gloss units, about 20 gloss units to about 30 gloss units, about 30 gloss units to about 40 gloss units, or any other range or value therebetween.

Methods may produce cured coatings having PCI visual smoothness values of 6 to 10, such as 6 to 7, 7 to 8, 7 to 9, or 7 to 10.

The resulting cured coating may have any desired thickness, such as about 5 microns to about 500 microns, about 10 microns to about 250 microns, about 20 microns to about 150 microns, about 25 microns to about 100 microns, about 50 microns to about 70 microns, or any other range or value therebetween. One having ordinary skill in the art with the benefit of this disclosure will be able to determine the appropriate thickness based on the end use and desired results.

The cured coating on the surface may be characterized by one or more 3-D surface roughness metrics measured on a microscopic scale, such as: Sa, arithmetic mean height, or Sq, root mean square height.

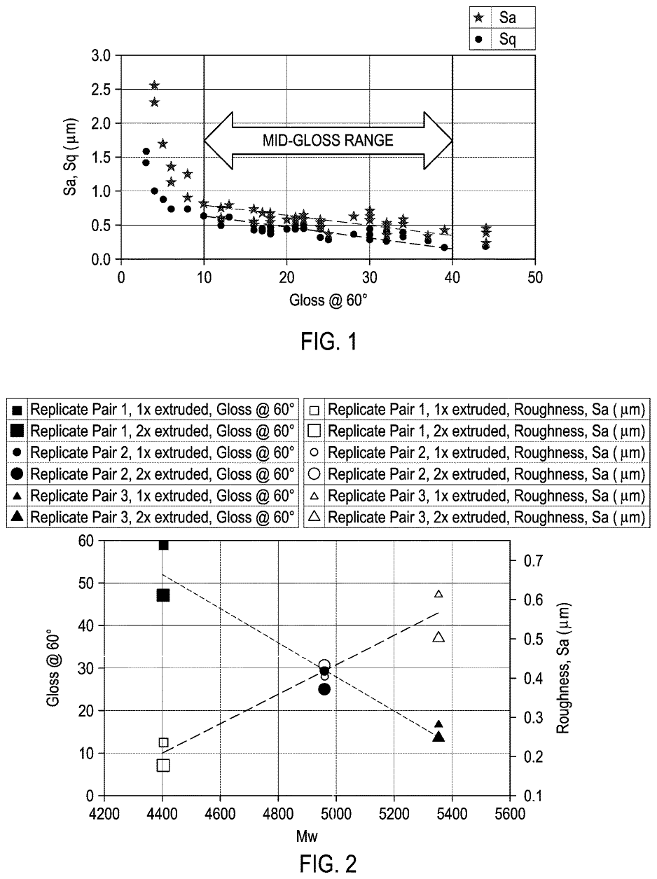

FIG. 1 shows that surface roughness reported as arithmetic mean height Sa and root mean square height Sq has a negative monotonic relationship with 60° gloss values in the mid-gloss range. Sa values in the range of about 0.2 to about 0.6 microns correspond to Sq values of about 0.3 to about 0.9 microns.

In some embodiments, the present disclosure relates to a cured coating, comprising: a glycidyl-functional poly(meth)acrylate polymer and a polyester, wherein the glycidyl-functional poly(meth)acrylate polymer and the polyester are cross-linked, the cured coating has an arithmetic mean roughness height (Sa) of about 0.2 microns to about 0.6 microns or a root mean square height (Sq) of about 0.3 microns to about 0.9 microns, and the cured coating has a 60° gloss of about 10 gloss units to about 40 gloss units.

### ADDITIONAL EMBODIMENTS

Embodiments disclosed herein include:

Embodiment A: A curing agent composition, comprising a glycidyl-functional poly(meth)acrylate polymer comprising about 10 wt % to about 20 wt % glycidyl (meth)acrylate units, about 50 wt % to about 80 wt % C1-C8 alkyl (meth)acrylate units, and about 8 wt % to about 15 wt % branched or cyclic C10-C20 hydrocarbyl or terpenyl (meth)acrylate units.

Embodiment B: A method, comprising a combination of: (a) a glycidyl-functional poly(meth)acrylate polymer comprising about 10 wt % to about 20 wt % glycidyl (meth)acrylate units, about 50 wt % to about 80 wt % C1-C8 alkyl (meth)acrylate units, and about 8 wt % to about 15 wt % branched or cyclic C10-C20 hydrocarbyl or terpenyl (meth)acrylate units; and

(b) a polyester having an acid value of about 20 to about 50, wherein the combining is at a temperature below the ring and ball softening point of the glycidyl-functional poly(meth)acrylate polymer, to yield an uncured powder coating composition.

Embodiment C: A method, comprising an uncured powder coating composition with:

(a) a glycidyl-functional poly(meth)acrylate polymer comprising about 10 wt % to about 20 wt % glycidyl (meth)acrylate units, about 50 wt % to about 80 wt % C1-C8 alkyl (meth)acrylate units, and about 8 wt % to about 15 wt % branched or cyclic C10-C20 hydrocarbyl or terpenyl (meth)acrylate units; and (b) a polyester having an acid value of about 20 to about 50; placing the uncured coating composition on a surface of an article; and heating the uncured coating at a temperature of about 150° C. to about 250° C. for a duration of about 0.1 minutes per micron of thickness of the uncured coating to about 1 minute per micron of thickness of the uncured coating, to yield a cured coating on the surface.

Embodiment D: An article, comprising a surface; and a cured coating on the surface, wherein the coating comprises (a) a glycidyl-functional poly(meth)acrylate polymer comprising about 10 wt % to about 20 wt % glycidyl (meth)acrylate units, about 50 wt % to about 80 wt % C1-C8 alkyl (meth)acrylate units, and about 8 wt % to about 15 wt % branched or cyclic C10-C20 hydrocarbyl or terpenyl (meth)acrylate units; and (b) a polyester having an acid value of about 20 to about 50, wherein the glycidyl-functional poly(meth)acrylate polymer and the polyester are cross-linked.

Embodiment E: a cured coating, comprising: a glycidyl-functional poly(meth)acrylate polymer and a polyester, wherein the glycidyl-functional poly(meth)acrylate polymer and the polyester are cross-linked, the cured coating has an arithmetic mean roughness height (Sa) of about 0.2 microns to about 0.6 microns or a root mean square height (Sq) of about 0.3 microns to about 0.9 microns, and the cured coating has a 60° gloss of about 10 gloss units to about 40 gloss units.

Each of the embodiments, A, B, C, D, and E, may have one or more of the following additional elements in any combination:

Element 1: wherein the branched or cyclic C10-C20 hydrocarbyl or terpenyl (meth)acrylate units comprise a unit selected from the group consisting of monoterpenyl (meth)acrylate units, monoterpenoidyl (meth)acrylate units, sesquiterpenyl (meth)acrylate units, sesquiterpenoidyl (meth)acrylate units, diterpenyl (meth)acrylate units, diterpenoidyl (meth)acrylate units, and any combination thereof.

Element 2: wherein the branched or cyclic C10-C20 hydrocarbyl or terpenyl (meth)acrylate units comprise isobornyl (meth)acrylate units.

Element 3: wherein the glycidyl-functional poly(meth)acrylate polymer has: a ring and ball softening point of about 100° C. to about 135° C.; an epoxide equivalent weight (EEW) of about 700 to about 1300; a glass transition temperature of about 45° C. to about 80° C.; a number-average molecular weight (Mn) of about 1600 to about 3400; a weight-average molecular weight (Mw) of about 3800 to about 6300; and a viscosity of about 50 cPs to about 250 cPs.

Element 4: further comprising a polyester having an acid value of about 20 to about 50.

Element 5: wherein the polyester and the glycidyl-functional poly(meth)acrylate are present in a weight ratio of about 40:60 to about 80:20.

Element 6: further comprising a compound selected from the group consisting of a catalyst, a flow control agent, a degassing agent, a pigment, a filler, and any combination thereof.

Element 7: wherein the composition comprises an imidazole catalyst.

Element 8: wherein the imidazole catalyst is present up to about 1 wt %.

Element 9: wherein the composition is present on the surface of a substrate.

Element 10: wherein the polyester and the glycidyl-functional poly(meth)acrylate are crosslinked together.

Element 11: wherein the composition has a 60° gloss of about 5 gloss units to about 45 gloss units.

Element 12: wherein the composition has a Powder Coating Institute (PCI) visual smoothness of 6 to 10.

Element 13: wherein the glycidyl-functional poly(meth)acrylate polymer and the polyester are further combined with (c) a compound selected from the group consisting of a catalyst, a flow control agent, a degassing agent, a pigment, a filler, and any combination thereof.

Element 14: wherein combining the glycidyl-functional poly(meth)acrylate polymer and the polyester comprises co-extrusion.

Element 15: wherein the uncured powder coating composition further comprises a compound selected from the group consisting of a catalyst, a flow control agent, a degassing agent, a pigment, a filler, and any combination thereof.

Element 16: wherein the uncured powder coating composition comprises an imidazole catalyst.

Element 17: further comprising: monitoring a transient gloss of the uncured coating during the heating; wherein the heating is terminated when the transient gloss has about a selected value.

Element 18: wherein the glycidyl-functional poly(meth)acrylate polymer has a weight-average molecular weight (Mw) of about 4700 to about 5200.

Element 19: wherein the cured coating on the surface has an arithmetic mean roughness height (Sa) of about 0.2 microns to about 0.6 microns or a root mean square height (Sq) of about 0.3 microns to about 0.9 microns.

Element 20: wherein the cured coating has a 60° gloss of about 20 gloss units to about 40 gloss units.

Element 21: wherein the cured coating has a 60° gloss of about 10 gloss units to about 40 gloss units.

Element 22: wherein the cured coating has a surface roughness Sa value that ranges between about 0.2 microns to about 0.6 microns, or an Sq that ranges between about 0.3 microns to about 0.9 microns.

By way of nonlimiting example, exemplary combinations applicable to A, B, C, D, and E include Elements 1-2, 1-3, 1-4, 1-5, 1-6, 1-7, 1-8, 1-9, 10-11, 10-12, 10-13, 10-14, 10-15, 10-16, 10-17, 10-18, 10-19, 10-20, 10-21, and 10-22.

### ADDITIONAL EMBODIMENTS

Embodiment 1. A curing agent composition, comprising: a glycidyl-functional poly(meth)acrylate polymer comprising: about 10 wt % to about 20 wt % glycidyl (meth)acrylate units; about 50 wt % to about 80 wt % C1-C8 alkyl (meth)acrylate units; and about 8 wt % to about 15 wt % branched or cyclic C10-C20 hydrocarbyl or terpenyl (meth)acrylate units.

Embodiment 2. The composition of embodiment 1, wherein the branched or cyclic C10-C20 hydrocarbyl or terpenyl (meth)acrylate units comprise a unit selected from the group consisting of monoterpenyl (meth)acrylate units, monoterpenoidyl (meth)acrylate units, sesquiterpenyl (meth)acrylate units, sesquiterpenoidyl (meth)acrylate units, diterpenyl (meth)acrylate units, diterpenoidyl (meth)acrylate units, and any combination thereof.

Embodiment 3. The composition of embodiment 1 or 2, wherein the branched or cyclic C10-C20 hydrocarbyl or terpenyl (meth)acrylate units comprise isobornyl (meth)acrylate units.

Embodiment 4. The composition of any one of embodiments 1 to 3, wherein the glycidyl-functional poly(meth)acrylate polymer has: a ring and ball softening point of about 100° C. to about 135° C.; an epoxide equivalent weight (EEW) of about 700 to about 1300; a glass transition temperature of about 45° C. to about 80° C.; a number-average molecular weight (Mn) of about 1600 to about 3400; a weight-average molecular weight (Mw) of about 3800 to about 6300; and a viscosity of about 50 cPs to about 250 cPs.

Embodiment 5. The composition of any one of embodiments 1 to 4, further comprising a polyester having an acid value of about 20 to about 50.

Embodiment 6. The composition of embodiment 5, wherein the polyester and the glycidyl-functional poly(meth)acrylate are present in a weight ratio of about 40:60 to about 80:20.

Embodiment 7. The composition of any one of embodiments 1 to 6, further comprising a compound selected from the group consisting of a catalyst, a flow control agent, a degassing agent, a pigment, a filler, and any combination thereof.

Embodiment 8. The composition of embodiment 7, wherein the composition comprises an imidazole catalyst.

Embodiment 9. The composition of embodiment 8, wherein the imidazole catalyst is present up to about 1 wt %.

Embodiment 10. The composition of any one of embodiments 1 to 9, which is present on the surface of a substrate.

Embodiment 11. The composition of embodiment 10, wherein the polyester and the glycidyl-functional poly(meth)acrylate are cross-linked together.

Embodiment 12. The composition of embodiment 11, wherein the composition has a 60° gloss of about 5 gloss units to about 45 gloss units.

Embodiment 13. The composition of any one of embodiments 10 to 12, wherein the composition has a Powder Coating Institute (PCI) visual smoothness of 6 to 10.

Embodiment 14. A method, comprising: combining: (a) a glycidyl-functional poly(meth)acrylate polymer comprising: about 10 wt % to about 20 wt % glycidyl (meth)acrylate units; about 50 wt % to about 80 wt % C1-C8 alkyl (meth)acrylate units; and about 8 wt % to about 15 wt % branched or cyclic C10-C20 hydrocarbyl or terpenyl (meth)acrylate units; and

(b) a polyester having an acid value of about 20 to about 50, wherein the combining is at a temperature below the ring and ball softening point of the glycidyl-functional poly(meth)acrylate polymer, to yield an uncured powder coating composition.

Embodiment 15. The method of embodiment 14, wherein the glycidyl-functional poly(meth)acrylate polymer and the polyester are further combined with (c) a compound selected from the group consisting of a catalyst, a flow control agent, a degassing agent, a pigment, a filler, and any combination thereof.

Embodiment 16. The method of embodiment 14 or 15, wherein combining the glycidyl-functional poly(meth)acrylate polymer and the polyester comprises co-extrusion.

Embodiment 17. A method, comprising: providing an uncured powder coating composition comprising: (a) a glycidyl-functional poly(meth)acrylate polymer comprising: about 10 wt % to about 20 wt % glycidyl (meth)acrylate units; about 50 wt % to about 80 wt % C1-C8 alkyl (meth)acrylate units; and about 8 wt % to about 15 wt % branched or cyclic C10-C20 hydrocarbyl or terpenyl (meth)acrylate units; and (b) a polyester having an acid value of about 20 to about 50; placing the uncured coating composition on a surface of an article; and heating the uncured coating at a temperature of about 150° C. to about 250° C. for duration of about 0.1 minutes per micron of thickness of the uncured coating to about 1 minute per micron of thickness of the uncured coating, to yield a cured coating on the surface.

Embodiment 18. The method of embodiment 17, wherein the uncured powder coating composition further comprises a compound selected from the group consisting of a catalyst, a flow control agent, a degassing agent, a pigment, a filler, and any combination thereof.

Embodiment 19. The method of embodiment 18, wherein the uncured powder coating composition comprises an imidazole catalyst.

Embodiment 20. The method of embodiment 17, 18, or 19, wherein the cured coating has a 60° gloss of about 5 gloss units to about 45 gloss units.

Embodiment 21. The method of any one of embodiments 17 to 20, wherein the cured coating has a Powder Coating Institute (PCI) visual smoothness of 6 to 10.

Embodiment 22. The method of any one of embodiments 17 to 21, further comprising: monitoring a transient gloss of the uncured coating during the heating; wherein the heating is terminated when the transient gloss has about a selected value.

Embodiment 23. The method of any one of embodiments 17 to 22, wherein the glycidyl-functional poly(meth)acrylate polymer has a weight-average molecular weight (Mw) of about 4700 to about 5200.

Embodiment 24. The method of embodiment 23, wherein the cured coating on the surface has an arithmetic mean roughness height (Sa) of about 0.2 microns to about 0.6 microns or a root mean square height (Sq) of about 0.3 microns to about 0.9 microns.

Embodiment 25. The method of embodiment 23 or 24, wherein the cured coating has a 60° gloss of about 20 gloss units to about 40 gloss units.

Embodiment 26. An article, comprising: a surface; and a cured coating on the surface, wherein the coating comprises: (a) a glycidyl-functional poly(meth)acrylate polymer comprising about 10 wt % to about 20 wt % glycidyl (meth)acrylate units; about 50 wt % to about 80 wt % C1-C8 alkyl (meth)acrylate units; and about 8 wt % to about 15 wt % branched or cyclic C10-C20 hydrocarbyl or terpenyl (meth)acrylate units; and (b) a polyester having an acid value of about 20 to about 50, wherein the glycidyl-functional poly(meth)acrylate polymer and the polyester are cross-linked.

Embodiment 27. The article of embodiment 26, wherein the cured coating has a 60° gloss of about 10 gloss units to about 40 gloss units.

Embodiment 28. The article of embodiment 26 or 27, wherein the cured coating has a Powder Coating Institute (PCI) visual smoothness of 6 to 10.

Embodiment 29. A cured coating, comprising: a glycidyl-functional poly(meth)acrylate polymer; and a polyester, wherein the glycidyl-functional poly(meth)acrylate polymer and the polyester are cross-linked, the cured coating has an arithmetic mean roughness height (Sa) of about 0.2 microns to about 0.6 microns or a root mean square height (Sq) of about 0.3 microns to about 0.9 microns, and the cured coating has a 60° gloss of about 10 gloss units to about 40 gloss units.

Embodiment 30. The cured coating of embodiment 29, wherein the cured coating has a Powder Coating Institute (PCI) visual smoothness of 6 to 10.

### EXAMPLES

To facilitate a better understanding of the embodiments of the present disclosure, the following examples of preferred or representative embodiments are given. In no way should the following examples be read to limit, or to define, the scope of the disclosure.

### Example 1: Synthesis of Glycidyl-Functional Poly(Meth)Acrylate Curing Agents

Curing Agent 1 (CA1) and Curing Agent 2 (CA2) were prepared as follows. A reactor was charged with solvent in which the headspace was purged with nitrogen and heated to reflux. (Meth)acrylate monomers in the proportions shown in Table 1, along with initiator, were added to the reactor.

TABLE 1

| Reagent | CA1 | CA2 |
|---|---|---|
| Glycidyl methacrylate (wt. parts) | 14-16 | 14-16 |
| Methyl methacrylate (wt. parts) | 70-75 | 70-75 |
| Butyl acrylate (wt. parts) | 0.5-1.5 | 0.5-1.5 |
| Isobornyl methacrylate (wt. parts) | 10-14 | — |
| Isobornyl acrylate (wt. parts) | — | 10-14 |

Solvent was then removed by vacuum distillation. CA1 and CA2 were then discharged from the reactor into a pan, air cooled, and ground. The ground product had a clear and granular appearance. Each reaction was performed in triplicate. Representative samples of CA1 and CA2 had the following properties:

TABLE 2

| Property | CA1 | CA2 |
|---|---|---|
| Ring and ball softening point (°C) | 116 | 118 |
| Epoxide equivalent weight | 1100 | 1000 |
| (gram polymer/mol epoxide) | | |
| Number-average molecular weight (Mn) | 2700 | 3000 |
| Weight-average molecular weight (Mw) | 5000 | 5000 |
| Z-average molecular weight (Mz) | 8300 | 8000 |
| Polydispersity Index (PDI) (Mw/Mn) | 1.8 | 1.7 |
| dn/dc | 0.098 | 0.097 |
| Glass transition temperature (Tg) (°C) | 64 | 60 |
| Viscosity (CAP 2000, 175 °C, 100 RPM) (cPs) | 170 | 105 |

### Example 2: Formulation of Powder Coating Compositions Comprising CA2

Eight uncured powder coating compositions S1-S4 and S1′-S4′ were prepared from CA2, polyester P1 (CC2441-2), flow control agents, benzoin, CIMBAR UF, SPECIAL BLACK 6, and imidazole catalyst ESCAT 50, with weight percentages as set forth in Table 3.

TABLE 3

| | S1 | S1′ | S2 | S2′ | S3 | S3′ | S4 | S4′ |
|---|---|---|---|---|---|---|---|---|
| P1 | 44.56% | 44.56% | 44.56% | 44.56% | 44.56% | 44.56% | 44.56% | 44.56% |
| CA2 | 28.64% | 28.64% | 28.64% | 28.64% | 28.64% | 28.64% | 28.64% | 28.64% |
| RESIFLOW PL-200 | 1% | 1% | | | | | | |
| RESIFLOW P-64F | | | 1% | 1% | | | | |
| RESIFLOW PH-241 | | | | | 1% | 1% | | |
| RESIFLOW PL-330 | | | | | | | 1% | 1% |
| Benzoin | 0.5% | 0.5% | 0.5% | 0.5% | 0.5% | 0.5% | 0.5% | 0.5% |
| ESCAT 50 | 0.3% | 0.3% | 0.3% | 0.3% | 0.3% | 0.3% | 0.3% | 0.3% |
| CIMBAR UF | 24% | 24% | 24% | 24% | 24% | 24% | 24% | 24% |
| SPECIAL BLACK 6 | 1% | 1% | 1% | 1% | 1% | 1% | 1% | 1% |
| 60° Gloss | 27 | 31 | 33 | 42 | 28 | 34 | 34 | 47 |
| PCI Smoothness | 7 | 7 | 6 | 6 | 6 | 6 | 7 | 7 |
| Surface Roughness Sa | 0.37 | 0.39 | 0.36 | 0.27 | 0.36 | 0.31 | 0.3 | 0.24 |
| Sq | 0.64 | 0.74 | 0.5 | 0.36 | 0.47 | 0.4 | 0.45 | 0.32 |

The components of each Sample S1-S4 and S1′-S4′ were mixed in a strand mill for 4-5 seconds, then extruded in a MP19PC Five zone extruder with the following conditions: 350 rpm/200 rpm, temperatures of about ambient temperature/65° C./65° C./105° C./105° C., and torque of about 40%-60%. After extrusion and cooling to room temperature, Samples S1-S4 and S1′-S4′ were ground in a strand mill. Samples S1-S4 were passed through a 140-mesh screen. Ground Samples S1′-S4′ were then remixed, re-extruded, re-cooled, reground, and passed through a 140-mesh screen prior to subsequent use.

Samples S1-S4 and S1′-S4′ were then used for powder coating a substrate such as untreated smooth mill QD low-carbon cold-rolled steel (3″×5″×0.020″) or aluminum panels (from Q-Lab, Westlake, OH) to a thickness of about 50 microns to about 70 microns, followed by curing at 200° C. for 15 minutes. The cured powder coatings of Samples S1-S4 were extruded once (1×) and the corresponding Samples S1′-S4′ were extruded twice (2×). Gloss measurements, PCI visual smoothness assessments, and surface roughness values for S1-S4 and S1′-S4′ are given in Table 3.

As can be seen in Table 3, 1× extruded Samples S1-S4 had comparable PCI visual smoothness compared to 2× extruded Samples S1′-S4′. However, Samples S1′-S4′ had higher gloss than their 1× extruded counterparts S1-S4.

### Example 3: Formulation of Powder Coating Compositions Comprising CA1

Eight uncured powder coating compositions S5-S12 were prepared from CA1, P1, RESIFLOW PL-200, benzoin, CIMBAR UF, SPECIAL BLACK 6, and imidazole catalyst ESCAT 50, with weight percentages as set forth in Table 4.

The components of each Sample S5-S12 were mixed, extruded, cooled, ground, and used for powder coating with thickness and curing, all substantially as in Example 2. Gloss measurements, PCI visual smoothness assessments, and surface roughness values for Samples S5-S12 are given in Table 4.

TABLE 4

| | S5 | S6 | S7 | S8 | S9 | S10 | S11 | S12 |
|---|---|---|---|---|---|---|---|---|
| P1 | 60.00% | 59.10% | 56.04% | 53.00% | 49.96% | 46.92% | 44.50% | 44.50% |
| CA1 | 38.20% | 38.10% | 36.16% | 34.20% | 32.24% | 30.28% | 28.70% | 28.70% |
| RESIFLOW PL-200 | 1% | 1% | 1% | 1% | 1% | 1% | 1% | 1% |
| Benzoin | 0.5% | 0.5% | 0.5% | 0.5% | 0.5% | 0.5% | 0.5% | 0.5% |
| ESCAT 50 | 0.3% | 0.3% | 0.3% | 0.3% | 0.3% | 0.3% | 0.3% | 0.3% |
| CIMBAR UF | | | 5% | 10% | 15% | 20% | 24% | |
| BLANC FIXE MICRO | | | | | | | | 24% |
| SPECIAL BLACK 6 | | 1% | 1% | 1% | 1% | 1% | 1% | 1% |
| Gloss 60° | 37 | 11 | 22 | 18 | 22 | 24 | 22 | 30 |
| PCI Smoothness | 3 | 8 | 7 | 7 | 7 | 7 | 8 | 7 |
| Surface Roughness Sa | — | 0.71 | 0.51 | 0.51 | 0.42 | 0.39 | 0.37 | 0.33 |
| Sq | — | 0.88 | 0.64 | 0.64 | 0.54 | 0.5 | 0.46 | 0.46 |

For each 1× extruded Sample S5-S6, S8, and S11-S12, an otherwise identical 2× extruded sample was also prepared. Negligible differences in gloss (about 1-3 gloss units and no more than about ±10%) and PCI visual smoothness between 1× extruded Samples S5-S6, S8, and S11-S12 and their 2× extruded counterparts were observed (data not shown).

### Example 4: Effect of Polyester/Glycidyl-Functional Poly(Meth)Acrylate Polymer Ratio and Barium Sulfate Content on Cured Coatings

Eight uncured powder coating compositions S13-S16 and S13′-S16′ were prepared from CA1, P1, RESIFLOW PL-200, benzoin, barium sulfate (CIMBAR UF), and ESCAT 50, with weight percentages as set forth in Table 5. The P1/CA1 weight ratio varied from a high of 65:35 (Samples S13 and S13′) which was expected to have an excess of polyester carboxyl groups over curing agent epoxide groups, to a low of 57:43 (Samples S14 and S14′), which was expected to have an excess of curing agent epoxide groups over polyester carboxyl groups. At a P1/CA1 weight ratio of 60:40, which was expected to have substantially equivalent amounts of polyester carboxyl groups and curing agent epoxide groups, barium sulfate levels of 5 wt % and 15 wt % were tested.

The components of each Sample S13-S16 and S13′-S16′ were mixed, extruded, cooled, and ground once (Samples S13-S16) or twice (S13′-S16′), and used for powder coating with thickness and curing, all substantially as in Example 2. Gloss measurements, PCI visual smoothness assessments, and surface roughness values for Samples S13-S16 and S13′-S16′ are presented in Table 5. All samples were substantially clear and lacked sparkle, cratering, orange peel, frosting, or other undesirable appearance.

As can be seen in Table 5, Samples S13 and S13′, which had a high P1/CA1 ratio of 65:35, had higher gloss values than Samples S14 and S14′, which had a low P1/CA1 ratio of 57:43. The lowest gloss values were observed for Samples S15-S16 and 515′-S16′, which had a P1/CA1 ratio of 60:40 and barium sulfate content of 5 wt % or 15 wt %.

TABLE 5

| | S13 | S13′ | S14 | S14′ | S15 | S15′ | S16 | S16′ |
|---|---|---|---|---|---|---|---|---|
| P1 | 63.8% | 63.8% | 56.0% | 56.0% | 56.8% | 56.8% | 50.8% | 50.8% |
| CA1 | 34.4% | 34.4% | 42.2% | 42.2% | 36.4% | 36.4% | 32.4% | 32.4% |
| P1/CA1 ratio | 65:35 | 65:35 | 57:43 | 57:43 | 60:40 | 60:40 | 60:40 | 60:40 |
| RESIFLOW PL-200 | 1% | 1% | 1% | 1% | 1% | 1% | 1% | 1% |
| Benzoin | 0.5% | 0.5% | 0.5% | 0.5% | 0.5% | 0.5% | 0.5% | 0.5% |
| ESCAT 50 | 0.3% | 0.3% | 0.3% | 0.3% | 0.3% | 0.3% | 0.3% | 0.3% |
| CIMBAR UF | | | | | 5% | 5% | 15% | 15% |
| Gloss 60° | 48 | 73 | 25 | 33 | 18 | 23 | 15 | 19 |
| PCI Smoothness | 7 | 7 | 7 | 7 | 7 | 7 | 7 | 7 |
| Surface Roughness Sa | — | — | — | — | 0.61 | 0.35 | 0.52 | 0.35 |
| Sq | — | — | — | — | 0.76 | 0.44 | 0.65 | 0.43 |

### Example 5: Effect of Catalyst Levels on Gloss of Cured Coatings

Six uncured powder coating compositions S17-S22 were prepared from CA1, P1, RESIFLOW PL-200, benzoin, barium sulfate (CIMBAR UF), and a catalyst, with weight percentages as set forth in Table 6. The only difference between Samples S17-S22 was the catalyst. Samples S17-S21 used imidazole catalysts; Sample S22 used castor wax as a control.

The components of each Sample S17-S22 were mixed, extruded, cooled, and ground (1×), and used for powder coating with thickness and curing, all substantially as in Example 2. Gloss measurements, PCI visual smoothness assessments, and surface roughness values for Samples S17-S22 are presented in Table 6.

As can be seen in Table 6, Samples S17-S21, comprising imidazole catalysts, yielded power coatings with mid-gloss gloss values. Samples S17-S21 were found to have high visual smoothness.

TABLE 6

| | S17 | S18 | S19 | S20 | S21 | S22 |
|---|---|---|---|---|---|---|
| P1 | 44.38% | 44.38% | 44.38% | 44.52% | 44.08% | 44.52% |
| CA1 | 28.62% | 28.62% | 28.62% | 28.72% | 28.42% | 28.72% |
| RESIFLOW PL-200 | 1% | 1% | 1% | 1% | 1% | 1% |
| Benzoin | 0.5% | 0.5% | 0.5% | 0.5% | 0.5% | 0.5% |
| ESCAT 50 | 0.5% | | | | | |
| ESCAT 60 | | 0.5% | | | | |
| ESCAT 66 | | | 0.5% | | | |
| IPI | | | | 0.26% | | |
| ZMBT | | | | | 1% | |
| Castor wax | | | | | | 0.26% |
| CIMBAR UF | 24 | 24% | 24% | 24% | 24% | 24% |
| SPECIAL BLACK 6 | 1% | 1% | 1% | 1% | 1% | 1% |
| Gloss 60° | 19 | 21 | 23 | 24 | 27 | 60 |
| PCI Smoothness | 7 | 6 | 6 | 6 | 6 | 7 |
| Surface Roughness Sa | 0.38 | 0.28 | 0.31 | 0.32 | 0.23 | 0.18 |
| Sq | 0.48 | 0.36 | 0.39 | 0.58 | 0.3 | 0.24 |

To assess the effect of imidazole catalyst level on 60° gloss, Samples S23-S27 were prepared with varied ESCAT 50 levels, as shown in Table 7, and powder coatings prepared therefrom as described in Example 2. 60′ gloss, visual smoothness, and surface roughness were determined as described in Example 2. Gloss tended to decrease with an increase of ESCAT 50. All samples S17 and S23-S27 had high visual smoothness.

TABLE 7

| | S23 | S24 | S25 | S26 | S27 |
|---|---|---|---|---|---|
| Polyester | 44.68% | 44.50% | 44.44% | 44.38% | 44.32% |
| CA1 | 28.82% | 28.70% | 28.66% | 28.62% | 28.58% |
| RESIFLOW PL-200 | 1% | 1% | 1% | 1% | 1% |
| Benzoin | 0.5% | 0.5% | 0.5% | 0.5% | 0.5% |
| ESCAT 50 | | 0.3% | 0.4% | 0.5% | 0.6% |
| CIMBAR UF | 24% | 24% | 24% | 24% | 24% |
| SPECIAL BLACK 6 | 1% | 1% | 1% | 1% | 1% |
| Gloss 60° | 53 | 21 | 21 | 20 | 18 |
| PCI Smoothness | 7 | 7 | 7 | 7 | 7 |
| Surface Roughness Sa | 0.19 | 0.4 | 0.37 | 0.38 | 0.36 |
| Sq | 0.24 | 0.51 | 0.48 | 0.48 | 0.45 |

To assess the effect of catalyst combinations on 60′ gloss, Samples S28-S32 were prepared with various catalyst combinations, as shown in Table 8. Powder coatings were prepared therefrom similarly to Example 2. 60′ gloss, visual smoothness, and surface roughness were determined as described in Example 2 with results shown in Table 8 for Samples S28-S32. All Samples S28-S32 yielded mid-gloss powder coatings. Samples S28-S32 were found to have high visual smoothness.

TABLE 8

| | S28 | S29 | S30 | S31 | S32 |
|---|---|---|---|---|---|
| Polyester | 44.68% | 44.54% | 44.44% | 44.30% | 44.36% |
| CA2 | 28.66% | 28.60% | 28.54% | 28.44% | 28.48% |
| RESIFLOW PL-200 | 1% | 1% | 1% | 1% | 1% |
| Benzoin | 0.5% | 0.5% | 0.5% | 0.5% | |
| ESCAT 50 | 0.3% | 0.5% | 0.5% | 0.3% | |
| ESCAT 73 | | | 0.16% | 0.6% | 0.8% |
| CIMBAR UF | 23.88% | 23.88% | 23.88% | 23.88% | 23.88% |
| SPECIAL BLACK 6 | 1% | 1% | 1% | 1% | 1% |
| Gloss 60° | 34 | 32 | 22 | 20 | 13 |
| PCI Smoothness | 7 | 7 | 7 | 7 | 7 |
| Surface Roughness Sa | 0.4 | 0.41 | 0.51 | 0.45 | 0.62 |
| Sq | 0.53 | 0.54 | 0.66 | 0.59 | 0.8 |

### Example 6: Effect of Cure Time and Temperature on Gloss of Cured Coatings

An uncured powder coating composition S33 was prepared with components and weight percentages thereof as set forth in Table 9. After extruding once, aliquots of S33 were powder coated onto a substrate and subjected to curing times and temperatures as shown in Table 9. A positive correlation between curing temperature and gloss was found.

TABLE 9

| | S33 | | |
|---|---|---|---|
| P1 | 44.6% | | |
| CA2 | 28.6% | | |
| RESIFLOW PL-200 | 1% | | |
| Benzoin | 0.5% | | |
| CIMBAR UF | 24% | | |
| ESCAT 50 | 0.3% | | |
| SPECIAL BLACK 6 | 1% | | |
| Cure conditions | 180 °C/30 min | 200 °C/15 min | 210 °C/10 min |
| Gloss at 60° | 22 | 31 | 31 |
| Surface Roughness Sa | 0.5 | 0.33 | 0.34 |
| Sq | 0.64 | 0.44 | 0.44 |

### Example 7: Effect of Polyester on Gloss of Cured Coatings

Twelve uncured powder coating compositions S34-S45 were prepared with components and weight percentages thereof as set forth in Table 10. After extruding once, Samples S34-S45 were powder coated onto a substrate and cured as described in Example 2. 60° gloss results are shown in Table 10. All Samples S34-S45 yielded mid-gloss powder coatings. Samples S34-S45 also had high visual smoothness.

TABLE 10

| | S34 | S35 | S36 | S37 | S38 | S39 | S40 | S41 | S42 | S43 | S44 | S45 |
|---|---|---|---|---|---|---|---|---|---|---|---|---|
| CC2440-0 (Allnex) | 44.38% | | | | | | | | | | | |
| CC2441-2 (Allnex) | | 44.38% | | | | | | | | | | |
| CC2606-2 (Allnex) | | | 44.38% | | | | | | | | | |
| CC4430-0 (Allnex) | | | | 44.38% | | | | | | | | |
| CC4478 (Allnex) | | | | | 44.38% | | | | | | | |
| REAFREE 4705 | | | | | | 44.38% | | | | | | |
| (Arkema) | | | | | | | | | | | | |
| REAFREE 6700 | | | | | | | 44.38% | | | | | |
| (Arkema) | | | | | | | | | | | | |
| URALAC 6620 | | | | | | | | 44.38% | | | | |
| (Covestro) | | | | | | | | | | | | |
| URALAC 6701 | | | | | | | | | 44.38% | | | |
| (Covestro) | | | | | | | | | | | | |
| ALYMERS TC3006 | | | | | | | | | | 44.38% | | |
| (Inopol) | | | | | | | | | | | | |
| SP-011 | | | | | | | | | | | 44.38% | |
| (Sun Polymer) | | | | | | | | | | | | |
| SP-6400 | | | | | | | | | | | | 44.38% |
| (Sun Polymer) | | | | | | | | | | | | |
| CA1 | 28.62% | 28.62% | 28.62% | 28.62% | 28.62% | 28.62% | 28.62% | 28.62% | 28.62% | 28.62% | 28.62% | 28.62% |
| RESIFLOW PL-200 | 1% | 1% | 1% | 1% | 1% | 1% | 1% | 1% | 1% | 1% | 1% | 1% |
| Benzoin | 0.5% | 0.5% | 0.5% | 0.5% | 0.5% | 0.5% | 0.5% | 0.5% | 0.5% | 0.5% | 0.5% | 0.5% |
| ESCAT 50 | 0.5% | 0.5% | 0.5% | 0.5% | 0.5% | 0.5% | 0.5% | 0.5% | 0.5% | 0.5% | 0.5% | 0.5% |
| CIMBAR UF | 24% | 24% | 24% | 24% | 24% | 24% | 24% | 24% | 24% | 24% | 24% | 24% |
| SPECIAL BLACK 6 | 1% | 1% | 1% | 1% | 1% | 1% | 1% | 1% | 1% | 1% | 1% | 1% |
| Gloss 60° | 23 | 24 | 20 | 49 | 25 | 26 | 27 | 35 | 46 | 41 | 34 | 27 |
| PCI Smoothness | 7 | 7 | 8 | 4 | 6 | 7 | 7 | 7 | 7 | 5 | 8 | 7 |
| Surface Roughness Sa | 0.38 | 0.35 | 0.49 | 0.15 | 0.36 | 0.3 | 0.31 | 0.23 | 0.23 | 0.23 | 0.21 | 0.34 |
| Sq | 0.49 | 0.46 | 0.64 | 0.19 | 0.46 | 0.39 | 0.44 | 0.29 | 0.29 | 0.31 | 0.29 | 0.44 |

### Example 8: Relationship Between Mw of Glycidyl-Functional Poly(Meth)Acrylate Polymer Curing Agents, Arithmetic Mean Height (Sa) of Cured Coatings, and Gloss Values

Three replicate pairs of CA1 were prepared that differed in Mw: Replicate Pair 1, Mw about 4400; Replicate Pair 2, Mw about 4950; and Replicate Pair 3, Mw about 5350. Two uncured powder coating compositions were prepared comprising a 60:40 ratio of polyester P1 with each replicate pair of CA1. For each pair of replicates, one uncured power coating composition was extruded once and the other uncured power coating composition was extruded twice, thus providing six data points total for the three pairs. The uncured powder coating compositions were applied to a substrate and cured as in Example 2. 60° gloss and surface roughness, Sa, were determined for each cured coating.

FIG. 2 shows 60° gloss (black shapes) and Sa values (unfilled shapes) for the three mid-gloss powder coating compositions (square, circle, triangle). The smaller of the two shapes comprising each replicate pair represents a 1× extruded coating and the larger shape is a 2× extruded coating. The best fits of 60° gloss to Mw and Sa to Mw are also shown (fine dashed line and coarse dashed line, respectively). As can be seen, 60° gloss values decreased with an increase of Mw, whereas Sa values increased with an increase of Mw. From the best fits, 60° gloss values in the range of 20-40 are expected for CA1 curing agents with Mw in the range of about 4700 to about 5200. This Mw range is expected to yield cured coatings with Sa values in the range of about 0.2 to about 0.6 microns.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood that we also contemplate the same composition or group of elements with transitional phrases “consisting essentially of,” “consisting of,” “selected from the group consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed considering the number of reported significant figures and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. A curing agent composition, comprising:
a glycidyl-functional poly(meth)acrylate polymer comprising:
about 10 wt % to about 20 wt % glycidyl (meth)acrylate units;
about 50 wt % to about 80 wt % C1-C8 alkyl (meth)acrylate units, wherein the C1-C8 alkyl moieties are linear or branched; and
about 8 wt % to about 15 wt % isobornyl (meth)acrylate units.

2-3. (canceled)

4. The composition of claim 1, wherein the glycidyl-functional poly(meth)acrylate polymer has:
a ring and ball softening point of about 100° C. to about 135° C.;
an epoxide equivalent weight (EEW) of about 700 to about 1300;
a glass transition temperature of about 45° C. to about 80° C.;
a number-average molecular weight (Mn) of about 1600 to about 3400;
a weight-average molecular weight (Mw) of about 3800 to about 6300; and
a viscosity of about 50 cPs to about 250 cPs as determined by a cone and plate viscometer at 175° C. and 100 rpm for a duration of 2 minutes, pursuant to ASTM D4287.

5. The composition of claim 1, further comprising a polyester having an acid value of about 20 ma KOH/q polyester to about 50 mg KOH/q polyester, pursuant to ASTM D7253.

6. The composition of claim 5, wherein the polyester and the glycidyl-functional poly(meth)acrylate are present in a weight ratio of about 40:60 to about 80:20.

7. The composition of claim 5, further comprising a compound selected from the group consisting of a catalyst, a flow control agent, a degassing agent, a pigment, a filler, and any combination thereof.

8. The composition of claim 5, wherein the composition comprises an imidazole catalyst.

9. The composition of claim 8, wherein the imidazole catalyst is present from about 0.1 wt % to about 1 wt %.

10. The composition of 5, which is present on a surface of a substrate.

11. The composition of claim 10, wherein the polyester and the glycidyl-functional poly(meth)acrylate are cross-linked together.

12. The composition of claim 11, wherein the composition has a 60° gloss of about 5 gloss units to about 45 gloss units.

13. The composition of claim 11, wherein the composition has a Powder Coating Institute (PCI) visual smoothness of 6 to 10.

14. A method, comprising:
combining:
a. a glycidyl-functional poly(meth)acrylate polymer comprising:
about 10 wt % to about 20 wt % glycidyl (meth)acrylate units;
about 50 wt % to about 80 wt % C1-C8 alkyl (meth)acrylate units; and
about 8 wt % to about 15 wt % branched or cyclic C10-C20 hydrocarbyl or terpenyl (meth)acrylate units; and
b. a polyester having an acid value of about 20 to about 50,
wherein the combining is at a temperature below the ring and ball softening point of the glycidyl-functional poly(meth)acrylate polymer, to yield an uncured powder coating composition.

15. The method of claim 14, wherein the glycidyl-functional poly(meth)acrylate polymer and the polyester are further combined with (c) a compound selected from the group consisting of a catalyst, a flow control agent, a degassing agent, a pigment, a filler, and any combination thereof.

16. The method of claim 14, wherein combining the glycidyl-functional poly(meth)acrylate polymer and the polyester comprises co-extrusion.

17. A method, comprising:
providing an uncured powder coating composition comprising:
a. a glycidyl-functional poly(meth)acrylate polymer comprising:
about 10 wt % to about 20 wt % glycidyl (meth)acrylate units;
about 50 wt % to about 80 wt % C1-C8 alkyl (meth)acrylate units; and
about 8 wt % to about 15 wt % branched or cyclic C10-C20 hydrocarbyl or terpenyl (meth)acrylate units; and
b. a polyester having an acid value of about 20 to about 50;
placing the uncured coating composition on a surface of an article; and
heating the uncured coating at a temperature of about 150° C. to about 250° C. for duration of about 0.1 minutes per micron of thickness of the uncured coating to about 1 minute per micron of thickness of the uncured coating, to yield a cured coating on the surface.

18. The method of claim 17, wherein the uncured powder coating composition further comprises a compound selected from the group consisting of a catalyst, a flow control agent, a degassing agent, a pigment, a filler, and any combination thereof.

19. The method of claim 18, wherein the uncured powder coating composition comprises an imidazole catalyst.

20. The method of 17, wherein the cured coating has a 60° gloss of about 5 gloss units to about 45 gloss units.

21. The method of claim 17, wherein the cured coating has a Powder Coating Institute (PCI) visual smoothness of 6 to 10.

22. The method of claim 17, further comprising: monitoring a transient gloss of the uncured coating during the heating; wherein the heating is terminated when the transient gloss has about a selected value.

23. The method of claim 17, wherein the glycidyl-functional poly(meth)acrylate polymer has a weight-average molecular weight (Mw) of about 4700 to about 5200.

24. The method of claim 23, wherein the cured coating on the surface has an arithmetic mean roughness height (Sa) of about 0.2 microns to about 0.6 microns or a root mean square height (Sq) of about 0.3 microns to about 0.9 microns.

25. The method of claim 23, wherein the cured coating has a 60° gloss of about 20 gloss units to about 40 gloss units.

26. An article, comprising:
a surface; and
a cured coating on the surface, wherein the coating comprises:
(i)
(a) a glycidyl-functional poly(meth)acrylate polymer comprising about 10 wt % to about 20 wt % glycidyl (meth)acrylate units; about 50 wt % to about 80 wt % C₁-C₈ alkyl (meth)acrylate units; and about 8 wt % to about 15 wt % branched or cyclic C₁₀-C₂₀ hydrocarbyl or terpenyl (meth)acrylate units; and
(b) a polyester having an acid value of about 20 to about 50, wherein the glycidyl-functional poly(meth)acrylate polymer and the polyester are cross-linked;
or
(ii)
a glycidyl-functional poly(meth)acrylate polymer; and
a polyester,
wherein the glycidyl-functional poly(meth)acrylate polymer and the polyester are cross-linked, and
the cured coating has an arithmetic mean roughness height (Sa) of about 0.2 microns to about 0.6 microns or a root mean square height (Sq) of about 0.3 microns to about 0.9 microns.

27. The article of claim 26, wherein the cured coating has a 60° gloss of about 10 gloss units to about 40 gloss units.

28. The article of claim 26, wherein the cured coating has a Powder Coating Institute (PCI) visual smoothness of 6 to 10.

29. The article of claim 26, wherein the cured coating comprises (i) (a) the glycidyl-functional poly(meth)acrylate polymer comprising about 10 wt % to about 20 wt % glycidyl (meth)acrylate units; about 50 wt % to about 80 wt % C1-C8 alkyl (meth)acrylate units; and about 8 wt % to about 15 wt % branched or cyclic C10-C20 hydrocarbyl or terpenyl (meth)acrylate units; and (b) the polyester having an acid value of about 20 to about 50.

30. The article of claim 27, wherein the cured coating comprises (ii) the glycidyl-functional poly(meth)acrylate polymer; and the polyester, wherein the cured coating has an arithmetic mean roughness height (Sa) of about 0.2 microns to about 0.6 microns or a root mean square height (Sq) of about 0.3 microns to about 0.9 microns.
